(19) United States
(12) Patent Application Publication
(10) Pub. No.: US 2022/0302943 A1
(43) Pub. Date: Sep. 22, 2022

(54) LOW POWER HIGH SENSITIVITY SENSE AMPLIFIER LATCH WITH COMPLIMENTARY OUTPUTS IN RESET MODE

(71) Applicant: Intel Corporation, Santa Clara, CA (US)

(72) Inventors: Chenchu Punnarao Bandi, Bangalorei (IN); Vijay Udupi Krishna, Bangalore (IN); Susmi T S, Kerala (IN); Sanjay Roul, Kerala (IN)

(73) Assignee: Intel Corporation, Santa Clara, CA (US)

(21) Appl. No.: 17/203,586

(22) Filed: Mar. 16, 2021

(51) Int. Cl. H04B 1/18; H04L 25/03; H04L 25/02; H04B 1/16

(52) U.S. Cl. CPC H04B 1/18; H04L 25/03318; H04L 25/0272; H04B 1/1676

(57) ABSTRACT

A sense amplifier latch (SAL) provides complimentary outputs in a reset phase to feed them directly to the Decision Feedback Equalizer (DFE) taps from SAL soft decision (d1x & d1xb) to improve the performance of DFE first tap 1-UI (one unit-interval) critical timing. The latch generates the complimentary resetting values on differential outputs in reset time. The latch enables in the required time i.e., once evaluation is done it shuts the current sinking path. The latch can extrapolate to rail-to-rail input common mode range of operation.

### BACKGROUND

As the data rates increase, the source synchronous parallel interfaces (e.g., double data rate generation 5 (DDRS), long reaching Die-to-Die interfaces, etc.) have more channel losses. Increment in channel length and multiple loading (e.g., a server DDR interface serves up to 7 inches, with 2 dual in-line memory modules (DIMMs) per channel and 2 memory ranks per DIMM) exacerbate channel losses. Decision Feedback Equalization (DFE) is used at a frontend of a receiver to extract data albeit channel losses. However, sampling and evaluating data at high speeds is a challenge.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a high-level architecture of a 4-tap DDR receiver path with separated even and odd summers, and a sense-amplifier latch (SAL), in accordance with some embodiments.

FIG. 2 illustrates a plot showing a timing diagram of 1^{st} tap feed signals that are tapped from SR-latch output in supply terminated links.

FIG. 3 illustrates an SAL with n-type input devices, in accordance with some embodiments.

FIG. 4 illustrates an SAL with offset cancellation and cross-talk compensation, in accordance with some embodiments.

FIG. 5 illustrates an SAL with p-type input devices, in accordance with some embodiments.

FIG. 6 illustrates an SAL with rail-to-rail common voltage, in accordance with some embodiments.

FIG. 7 illustrates a smart device or a computer system or an SoC (System-on-Chip) with SAL, in accordance with some embodiments.

### DETAILED DESCRIPTION

DFB works based on previous data bits to estimate Inter-Symbol-Interference (ISI) on current bit while sampling the current bit. The time (1-UI delay) required to avail the immediate previous bit (major ISI contributor) plays a critical role in choosing the DFE architecture for efficiency in terms of area and power. Some contributors of that time are sense amplifier latch (SAL) T_{CO} (clock-to-Q delay), SR-latch and settling time of DFE summer after applying the previous bit to taps. For higher sampling rates (e.g., greater than 4000 MT/s data rates) the sense amplifier is expected to have the lowest T_{CO} and also meet other performance parameters such as sensitivity, offset, low power and lower supply voltage for best Key Performance Indicator (KPI) metrics.

Some embodiments provide an innovative sense amplifier latch (SAL) which provides complimentary outputs in a reset phase to feed them directly to DFB taps from SAL soft decision (d1x & d1xb) without compromising the performance of DFE first tap 1-UI critical timing. In some embodiments, the SAL generates complimentary resetting values on differential outputs in reset phase compared to both outputs to VCC/VSS in all available state of art SAL architectures. In some embodiments, the SAL is enabled during an evaluation phase and shuts its current sinking path once the evaluation phase is complete. The SAL of various embodiments can extrapolate to rail-to-rail input common mode range of operation.

In some embodiments, the SAL comprises a first stage having a differential input pair and cross-coupled transistors coupled to the differential input pair; and a second stage coupled to the first stage such that the first stage is to fold in to the second stage, wherein the second stage comprises cross-coupled inverters. Here, the term fold refers to coupling input transistors of one conductivity type to transistors of a second conductivity type. For example, differential input n-type transistors are coupled to two p-type transistors that are coupled to a supply node. The coupling of the transistors forms a cascode arrangement, or simply a cascode. A cascode is an arrangement of transistors where a common-source stage feeds into a common-gate stage to combine the transconductance of the former with the output impedance of the latter. This improves gain when driving high-impedance loads, such as the input of a later transistor stage. Additionally, because the drain of a transistors of the common-source stage is now held at a near-constant voltage, the severity of Miller effect upon the frequency response is reduced.

In some embodiments, the cross-coupled inverters comprise a first inverter and a second inverter, wherein the sense amplifier latch comprises a first pass gate controllable by a clock, wherein the first pass-gate is to couple or de-couple transistors of the first inverter from a first output of the first inverter, wherein the first output is coupled to an input of the second inverter. In some embodiments, the sense amplifier latch comprises a second pass gate controllable by the clock, wherein the second pass-gate is to couple or de-couple transistors of the second inverter from a second output of the first inverter, wherein the second output is coupled to an input of the first inverter.

In some embodiments, the SAL comprises a first device coupled in parallel to a transistor of the first inverter, and also coupled to a supply rail. In some embodiments, the SAL comprises a second device coupled in parallel to a transistor of the second inverter, and also coupled to the supply rail. In some embodiments, the SAL comprises a first driver coupled to the transistor of the first inverter; and a second driver coupled to the transistor of the second inverter. In some embodiments, the SAL comprises: a first transistor coupled to the differential input pair and cross-coupled transistors, wherein the first transistor is controllable by a first clock; and a second transistor coupled to the differential input pair and a reference supply, and controllable by a second clock, wherein the second clock is an inverse of the first clock. In some embodiments, the SAL comprises a cross-talk cancellation circuitry coupled to the differential pair. In some embodiments, the SAL comprises a high-pass filter coupled to the cross-talk cancellation circuitry coupled to the differential pair. In some embodiments, the SAL comprises a voltage offset control circuitry coupled to the differential pair.

There are various technical effects of these embodiments. For example, the SAL of various embodiments reduces the 1st tap DFE delay time up to 15% compared to known DFE 1st tap DFE delay time. The SAL of various embodiments mitigates worst case latency impacts at higher data rates compared to existing solutions. The SAL saves up to 10% power saving compared to existing double tail strong arm latches. In some embodiments, the SAL can work at lower supply voltages which helps to reduce the voltage of an entire Physical domain (PHY). For example, the SAL enables half-rate DFE architecture up to 10 GBPS at 0.82 V nominal voltage in place of loop un-rolling or higher nominal voltage for half-rate DFE architecture. Other technical effects will be evident from the various embodiments and figures.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

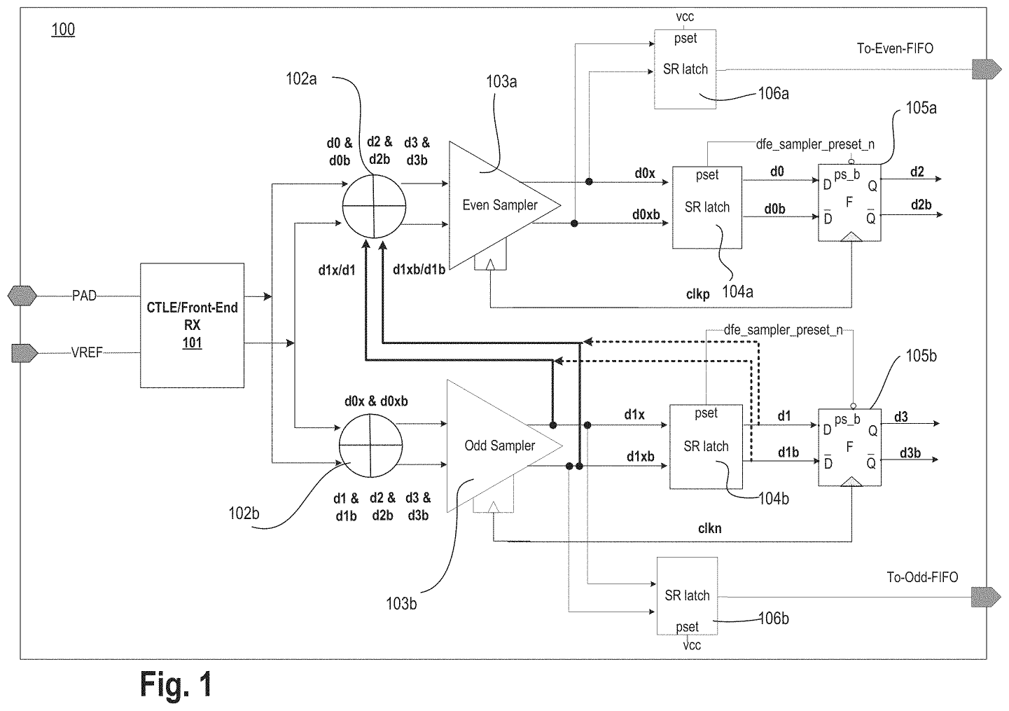

FIG. 1 illustrates high-level architecture 100 of a 4-tap DDR receiver path with separated even and odd summers, and a sense-amplifier latch (SAL), in accordance with some embodiments. Architecture 100 comprises an analog front-end (AFE) 101, analog summing nodes 102a and 102b, SAL even sampler 103a, SAL odd sampler 103b, set-reset (SR) latch 104a, SR latch 104b, first flip-flop 105a, second flip-flop 105b, SR latch 106a, and SR latch 106b.

In some embodiments, AFE 101 comprises a linear equalizer. For example, AFE 101 performs continuous time linear equalization (CTLE). AFE 101 receives an analog signal on a PAD pin from a channel (e.g., a lossy channel) and a reference voltage (VREF) on a VREF pin. The output of AFE 101 is a differential analog signal d0 and d0b (where d0b is a complement of d0). For simplicity, architecture 100 shows a 4-tap, however actual design can have any number of taps (e.g., up to 6-Taps). The DFE summing nodes 102a and 102b and taps are designed with fully differential half rate (even and odd data-path) architecture on the output of AFE 101. For even data sampling, the immediate previous odd data comes from SR-latch differential outputs (d1 and d1b), so the 1-UI (one unit-interval) delay includes SAL T_{CO} (e.g., T_{CO} of SALs 103a, 103b) and SR-Latch (e.g., 104a, 104b). The summing nodes 102a and 102b also receive subsequent sampled differential outputs. For example, summing node 102a receives outputs d2 and d2b from FF 105a, d3 and d3b from FF 105b, output d1x and d1xb of odd sampler 103b, d1 and d1b from SR latch 104b. Likewise, summing node 102b receives outputs d2 and d2b from FF 105a, d3 and d3b from FF 105b, output d0x and d0xb of even sampler 103a, d1 and d1b from SR latch 104b. Here, dfe_sampler_preset_n is used to reset all the taps at early of data burst. For example, if the link/bus is supply terminated at the beginning of data burst, all the taps are preset to one, or if the link/bus is supply terminated at beginning of data burst, all the taps are preset to zero. SR latch 104a/b holds the sampled data while SAL enters in to reset mode after evaluation/sample-state. FF 105a/b shifts and holds the previous (N−1) bit such that summer nodes will see N−2 bit for sampling current bit properly. In a 6-tap DFE case, two more flops are added, one in the even path and the other one in the odd path.

Here, clkn and clkp are 180-degree phase shifted clocks (or differential clocks) that determine the reset phase and evaluation phase for SALs 103a and 103b. For example, during high-phase of clkn, odd sampler SAL 103b is in evaluation phase where it evaluates the outputs of summing node 102b and generates evaluated signals d1x and d1xb, while during low-phase of clkn, odd sampler SAL 103b is in reset phase.

When SALs 103a and 103b use traditional SALs such as telescopic SALs, the SALs provide slower evaluation speeds (e.g., up to 8 GBPS at 0.9 V supply), suffer from very tight timing constraints for 1-UI timings, and use higher power supply voltages. When SAL 103a and 103b use traditional SALs such as double-tail SAL, then the SALs consume 2× more power than telescopic SALs for the same speed as telescopic SALs, and suffer from similar challenges as telescopic SALs. In various embodiments, SAL 103a and 103b use two stage SAL architecture with a first stage folded on to a second stage with current summing. The SAL of various embodiments is capable of evaluating data at higher speeds (e.g., 10 GBPS at 0.8 V or 12 GBPS at 0.9 V supply) than traditional SALs at lower supply voltages. The SAL of various embodiments have higher drive strength at the load compared to traditional SALs and provide better T_{CO} than traditional SALs.

The SALs 103a and 103b of various embodiments provides complimentary outputs in a reset phase to feed them directly to DFE taps from SAL soft decision (d1x & d1xb) without compromising the performance of DFE first tap 1-UI critical timing. In some embodiments, SALs 103a and 103b generate complimentary resetting values on differential outputs in reset phase compared to both outputs to VCC/VSS in all available state of art SAL architectures. In some embodiments, SALs 103a and 103b are partly enabled during an evaluation phase and shut their current sinking path in the evaluation phase to save the overall active power. SALs 103a and 103b of various embodiments can extrapolate to rail-to-rail input common mode range of operation.

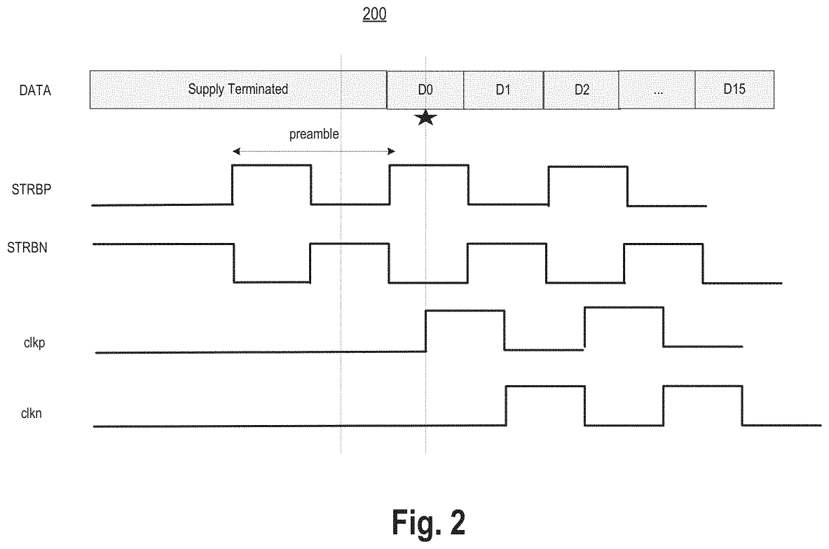

FIG. 2 illustrates plot 200 showing a timing diagram of 1^{st} tap feed signals that are tapped from SR-latch output in supply terminated bus. In links such as Die-2-Die interconnects, R-Link, DDR etc., for power efficiency, clock (STRBP and STRBN) is only available for a few cycles of a preamble before the data bursts. At the starting of the burst, the sampling clocks are not differential but start from zero (e.g., clkp and clkn) to avoid any wrong sampling due to glitch on the parked bus. i.e. the “clkn” sampler (odd) will be in reset phase while “clkp” (even) trying to sample the first bit. So, the output of the odd sampler going to differential DFE even summer needs to be defined as complimentary values as 1 and 0 (in supply terminated bus) as part of SR-Latch or separately, which adds another stage in 1-UI timing along with SAL and SR-Latch in state-of-art existing SAL where in its outputs are non-complimentary (i.e., 0 & 0 or 1 &1). Serial links also have this problem, but since power up/down exit latency is not critical, the first few bits can be discarded unlike in DDR, R-Link, Die-to-die interconnects. Various embodiments use a sense amplifier latch that provides complimentary outputs in reset phase to feed them directly to the DFE taps from SAL soft decision (d1x & d1xb) without compromising the performance of DFE first tap 1-UI critical timing.

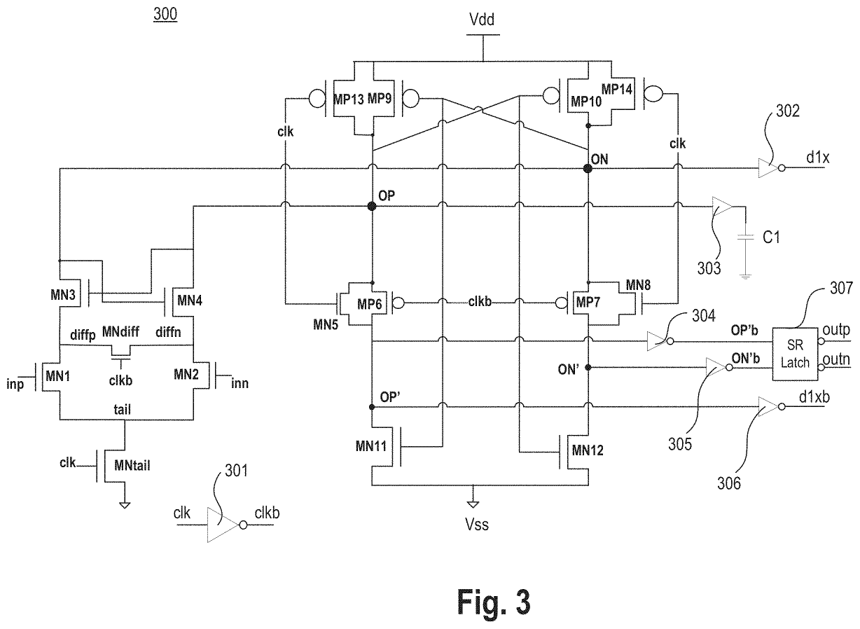

FIG. 3 illustrates SAL 300 with n-type input devices, in accordance with some embodiments. SAL 300 comprises a first stage and a second stage, wherein the first stage is coupled on the second stage with current summing In some embodiments, the first stage comprises clock (clk) enabled current source MNtail coupled to node tail and ground, n-type input devices MN1 and MN2 that receive inputs inp and inn, respectively, n-type differential equalizing transistor MNdiff controllable by clkb (inverse of clk) and coupled to nodes diffp and diffn, and cross-coupled n-type transistors MN3 and MN4 which are folded on to the second stage. In some embodiments, the second stage comprises first pass-gate comprising MN5 and MP6 controllable by clk and clkb, respectively, and second pass-gate comprising MN8 and MP7 controllable by clk and clkb, respectively. Clock clkb is generated by clock clk via inverter 301.

The first pass gate couples or de-couples nodes OP with OP′. The second pass gate couples or de-couples nodes ON with ON′. In various embodiments, the voltage on node OP controls transistor MN3 while the voltage on node ON controls transistor MN4. In some embodiments, the drain of transistor MN3 is coupled to node ON, while the drain of transistor MN4 is coupled to node OP. Here, node names and signal names are interchangeably used. For example, ON may refer to signal ON or node ON depending on the context of the sentence.

In some embodiments, the second stage comprises cross-coupled inverters including a first inverter having transistors MP9 and MN11, and a second inverter having transistors MP10 and MN12. The inverters are cross-coupled by having the output OP of the first inverter coupled to the input (gate terminals) of the second inverter, and having the output ON of the second inverter coupled to the input (gate terminals) of the first inverter. In some embodiments, additional p-type transistors MP13 and MP14 are coupled in parallel to MP9 and MP10, respectively and controllable by clk.

As shown in FIG. 3, the first stage output is fed to a second stage, in a folded cascode fashion which avoids stacking of devices compared to single tail SAL architecture. In the stage, while in reset, OP/ON nodes are pulled up to Vcc, while OP′/ON′ nodes are pulled down to VSS, so at the start of the evaluation phase both OP/ON nodes are shorted to OP′/ON′ through pass-gates switch. As such, the second stage evaluation starts at an inverter trip point (half-VCC) that improves T_{CO}. The first and second stages together form a folded cascode amplifier.

A folded cascode amplifier comprises of a common source transistor cascoded with a common gate transistor of the opposite polarity. A differential pair MN1 and MN2 is used as the input stage to the amplifier, acting as the common source portion of the cascade. The drains of the input transistors are then linked (e.g., via transistors MN3 and MN4) to two opposite polarity common gate transistors (e.g., MP9 and MP10). The common gate transistors are then connected to an active current source load (e.g., MN11 and MN12) to complete the circuit. By “folding” the cascode over into a pair of opposite polarity transistors, this decreases the required headroom for the circuit, giving the same performance as a typical cascode amplifier, but with a lower required supply voltage.

In some embodiments, there is no stacking impact in SAL 300 since the second stage evaluation starts at one threshold (Vt) delta/swing from supply at inverter trip point. In some embodiments, the cross-coupled inverters (or back-to-back inverters) in the second stage enhance speed and performance of SAL 300. In some embodiments, MN11 and MN12 devices of the cross-coupled inverters work as resetting devices for OP′ and ON′ eliminates (or substantially eliminates) the need of separate pull-down devices in the state of art SAL. In some embodiments, charge sharing phenomenon between OP/ON at supply and OP′/ON′ at ground in reset forces/balances the inverter trip point to mid-rail once the SAL 300 entered in to evaluation by shorting OP & OP′ and ON & ON′ to resolve the decision, which results in the shortest TCO of SAL 300.

In some embodiments, outputs of the second stage are buffered or inverted to generate d1x, d1xb, OP′b, and ON′b. In one such example, inverters 302, 303, 304, 305, and 306 are used. The inverters can be replaced with any suitable drivers such as buffers, NAND gates, OR gates, NOR gates etc. In some embodiments, d1x and d1xb are generated for summing nodes 102a and 102b, while less timing critical outputs OP′b and ON′b are received by SR latch 307 (e.g., SR latch 104a, 104b, 106a, 106b). In this example, inverter or buffer 303 is added for load matching on node OP. The output of inverter or buffer 303 is coupled to a dummy load represented by a capacitor C1.

In some embodiments, MP13 and MP14 devices bring OP and ON nodes to Vcc in reset mode when clk is zero. In various embodiments, MN5, MP6, and MP7, MN8 form pass gate switches to make or break the second stage cross-coupled inverter. In some embodiments, transistors MN3 and MN4 help to suppress the output nodes (OP and ON) kick back (e.g., while OP/ON is switching rail-to-rail, there will be parasitic capacitance coupling from transistors MN1 and MN2 drain-to-gate or input without transistors MN3 and MN4) into input devices.

In reset mode, clk=Vss and clkb=Vcc, OP and ON nodes are forced to Vcc by devices MP13 and MP14. In this case, diffp and diffn nodes are set to Vcc-Vtn and OP′ and ON′ nodes are pulled to Vss. Transistors MN5, MP6, and MP7, MN8 form two pass gate switches that are turned OFF and break the second stage cross-coupled inverter which disconnects OP & OP′ nodes and ON & ON′ nodes. When the clk and clkb are differentially generated, the clkb is generated by local inversion from clk, wherein clkb is Vss at starting of burst (like in DDR/Die-2-Die connections where strobe appears just before the data burst) to disconnect the second stage supply to ground connection through MP6 and MP7 devices in reset phase. So, in reset phase OP and ON nodes are at Vcc and OP′ and ON′ nodes are at Vss as complimentary output phases for DFE first tap tapping directly.

In evaluation mode, when clk is equal to Vcc and clkb is equal to Vss, transistors MP13 and MP14 are turned OFF. Transistors MN5, MP6 and MP7, MN8 form pass gate switches that are turned ON to complete the 2nd stage cross-coupled inverter by shorting the OP node with the OP′ node, and by shorting the ON node with the ON′ node. These four nets drift towards equilibrium point at mid-rail and ready to resolve once one of the OP or ON nodes reaches below to Vcc-Vtp. As such, SAL 300 improves its TCO compared to other traditional SALs. The nodes diffp and diffn are separated once the differential voltage build up triggers the second stage outputs to Vcc and Vss.

Once the voltages on the ON and OP nodes are defined by transistors MN3 and MN4, devices will shut off the current from the first stage. As such, power is saved by SAL 300 compared to double tail SALs. The second stage cross-coupled inverter provides faster regeneration of voltages on nodes OP and ON as well as nodes OP′ and ON′, thereby overcoming the impact of series resistance offered by pass gate switches. These devices MN11 & MN12 also enable self-resetting of OP′ and ON′ nodes to ground during reset with slight direct loading from MN11 and MN12 on OP and ON nodes.

In various embodiments, the T_{CO} of SAL 300 is better than other existing state of the art SAL options even at lower supplies (e.g., 0.8 V and below). SAL 300 provides better power performance than double tail SAL at lower supply with nearby single tail power. SAL 300 enables SAL output differential soft decision usage in reset phase, which reduces 1st tap DFE time. For example, almost 50% reduction in 1st tap DFE timing is achieved, which avoids loop un-rolling that results in power saving. In one example, half-rate clocking for DFE, up to 10 GBPS at 0.8 V and 12 GBPS at 0.9 V is achieved using SAL 300.

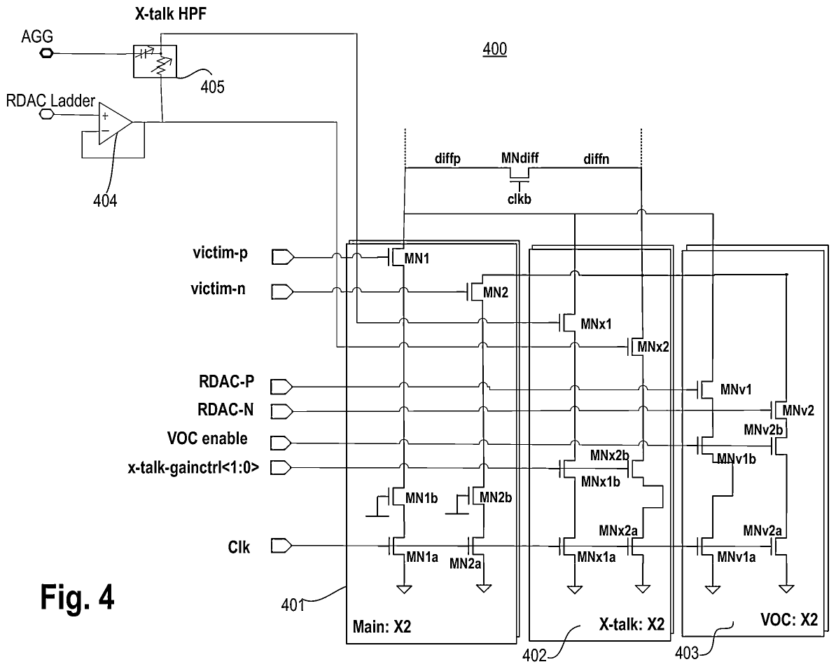

FIG. 4 illustrates SAL 400 with offset cancellation and cross-talk compensation, in accordance with some embodiments. For simplicity, here the tail section of the first stage is illustrated. The dotted lines on nodes diffp and diffn indicate the remaining part of the first stage which is coupled to the second stage as discussed with reference to FIG. 3. In some embodiments, SAL 400 comprises a first circuitry 401, second circuitry 402, and third circuitry 403.

In some embodiments, first circuitry 401 functions as the input pairs MN1 and MN2 that receive inputs victim-p (same as inp) and victim-n (same as inn) for crosstalk cancellation pair. In crosstalk correction terminology, the crosstalk actually happens on current (victim) lane by neighbor (Aggressor) lane. Since each stack of devices in first circuitry 401, second circuitry 402, and third circuitry 403 have three devices in a stack, n-type devices MN1b and MN2b are added in series between MN1 and MN1a, and MN2 and MN2a, respectively. Devices MN1b and MN2b are kept on in this case. With all these sub circuits 402, 403 on diffp and diffn nets, the SAL performance does not deteriorate as the parasitic loading from all these sub circuit parasitic is isolated by transistors MN3 and MN4 of SAL. However, in some embodiments, an enable signal can be used to turn on/off devices MN1b and MN2b. Clk signal is used to control MN1a and MN2a, where MN1a and MN2a are equivalent to the MNtail of FIG. 3.

In some embodiments, second circuitry 402 is used for cross-talk cancellation or compensation. Second circuitry 402 comprises two stacks of devices. One stack is coupled to node diffp while the other stack is coupled to diffn. The first stack of devices comprises n-type transistors MNx1, MNx1b, and MNx1a. The second stack of devices comprises n-type transistors MNx2, MNx2b, and MNx2a. Devices MNx1 and MNx2 are coupled to nodes diffp and diffn, respectively, and controlled by analog signals from a high-pass filter 405 (X-talk HPF). Any suitable high-pass filter may be used for implementing high-pass filter 405. High-pass filter 405 receives an analog input AGG (Aggressor) and provides a filtered version of AGG to the gate of MNx2. The analog input AGG is a neighbor aggressor lane (e.g., next lane to the receiver lane having SAL 400). In some embodiments, the output of unity gain amplifier 404 is used to control MNx2. In some embodiments, MNx1b and MNx2b are controlled by cross-talk gain control signal (x-talk0gainctrk<1:0>), which is a digital signal or code. In this example, x-talk0gainctrk<1:0> is a 2-bit bus. Clk signal is used to control MNx1a and MNx2a, where MNx1a and MNx2a are equivalent to the MNtail of FIG. 3.

In some embodiments, third circuitry 403 is used for voltage offset control (VOC). Third circuitry 403 comprises two stacks of devices. One stack is coupled to node diffp while the other stack is coupled to diffn. The first stack of devices comprises n-type transistors MNv1, MNv1b, and MNv1a. The second stack of devices comprises n-type transistors MNv2, MNv2b, and MNv2a. MNv1 and MNv2 are controlled by control voltages RDAC-P and RDAC-N. RDAC-P and RDAC-N may be generated by a resistor DAC (digital-to-analog converter). MNv1b and MNv2b are controllable by an enable signal VOC which enables the offset compensation by third circuitry 403. Clk signal is used to control MNv1a and MNv2a, where MNv1a and MNv2a are equivalent to the MNtail of FIG. 3.

First, second, and third circuitries 401, 402, and 403, respectively, ensure that nodes OP, ON, OP′, and PN′ are load balanced. In some embodiments, the d1x/d1xb outputs directly drive the DFE summer 102a/b through inverter 302/306, respectively. During reset phase, d1x/d1xb nodes are parked to I/O for both SALs 103a/b, which helps even SAL 103a to directly tap from odd SAL 103b with smallest amount of time to maintain half-rate DFE function.

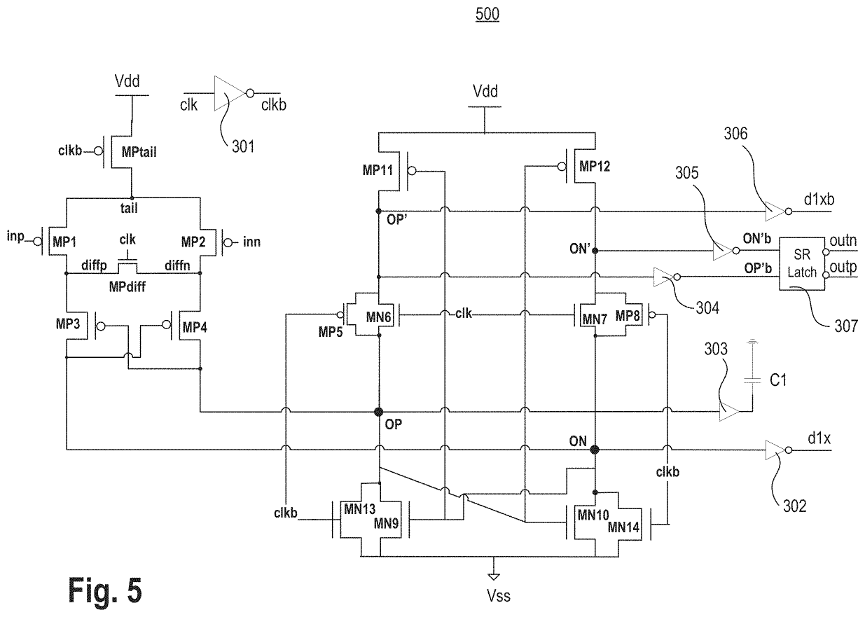

FIG. 5 illustrates SAL 500 with p-type input devices, in accordance with some embodiments. SAL 500 is similar to SAL 300. SAL 500 comprises a first stage and a second stage, wherein the first stage is coupled to the second stage with current summing In some embodiments, the first stage comprises clock (clkb) enabled current source MPtail coupled to node tail and supply Vdd, p-type input devices MP1 and MP2 that receive inputs inp and inn, respectively, p-type differential equalizing transistor MPdiff controllable by clk (inverse of clkb) and coupled to nodes diffp and diffn, and cross-coupled p-type transistors MP3 and MP4 which are folded on to the second stage. In some embodiments, the second stage comprises first pass-gate comprising MP5 and MN6 controllable by clkb and clk, respectively, and second pass-gate comprising MP8 and MN7 controllable by clkb and clk, respectively. Clock clkb is generated by clock clk via inverter 301.

The first pass gate couples or de-couples nodes OP with OP′. The second pass gate couples or de-couples nodes ON with ON′. In various embodiments, the voltage on node OP controls transistor MN3 while the voltage on node ON controls transistor MN4. In some embodiments, the drain of transistor MN3 is coupled to node ON, while the drain of transistor MN4 is coupled to node OP.

In some embodiments, the second stage comprises cross-coupled inverters including a first inverter having transistors MN9 and MP11, and a second inverter having transistors MN10 and MP12. The inverters are cross-coupled by having the output OP of the first inverter coupled to the input (gate terminals) of the second inverter, and having the output ON of the second inverter coupled to the input (gate terminals) of the first inverter. In some embodiments, additional p-type transistors MP13 and MP14 are coupled in parallel to MP9 and MP10, respectively and controllable by clkb.

As shown in FIG. 5, the first stage output is fed to a second stage, in a folded cascode fashion which avoids stacking of devices compared to single tail SAL architecture. In the stage, while in reset, OP/ON nodes are pulled down to Vss, while OP′/ON′ nodes are pulled up to Vdd, so at the start of the evaluation phase both OP/ON nodes are shorted to OP′/ON′ through pass-gates switches. As such, the second stage evaluation starts at an inverter trip point (half-VCC) that improves T_{CO}. In some embodiments, there is no stacking impact in SAL 500 since the second stage evaluation starts at one threshold (Vt) delta/swing from supply at inverter trip point. In some embodiments, the cross-coupled inverters (or back-to-back inverters) in the second stage enhance speed and performance of SAL 500. In some embodiments, MP11 and MP12 devices of the cross-coupled inverters work as resetting devices for OP′ and ON′ eliminating (or substantially eliminating) the need of separate pull-down devices in the state-of-the-art SAL. In some embodiments, charge sharing phenomenon between OP/ON at supply and OP′/ON′ at ground in reset forces/balances the inverter trip point to mid-rail once the SAL 500 enters in evaluation phase by shorting OP & OP′ and ON & ON′ to resolve the decision, which results in the shortest TCO of SAL 500.

In some embodiments, outputs of the second stage are buffered or inverted to generate d1x, d1xb, OP′b, and ON′b. In one such example, inverters 302, 303, 304, 305, and 306 are used. The inverters can be replaced with any suitable drivers such as buffers, NAND gates, OR gates, NOR gates etc. In some embodiments, d1x and d1xb are generated for summing nodes 102a and 102b, while less timing critical outputs OP′b and ON′b are received by SR latch 307 (e.g., SR latch 104a, 104b, 106a, 106b). In this example, inverter or buffer 303 is added for load matching on node OP. The output of inverter or buffer 303 is coupled to a dummy load represented by a capacitor C1.

In some embodiments, MN13 and MN14 devices bring OP and ON nodes to Vss in reset mode when clkb is zero. In various embodiments, MP5, MN6, and MN7, MP8 form pass gate switches to make or break the second stage cross-coupled inverter. In some embodiments, transistors MP3 and MP4 help to suppress the output nodes (OP and ON) kick back (i.e., while OP/ON switches rail-to-rail, there will be parasitic capacitance coupling from MN1 and MN2 drain to gate or input without MP3 and MP4) into input devices.

In reset mode, where clkb=Vss and clk=Vcc, OP and ON nodes are forced to Vss by devices MN13 and MN14. In this case, diffp and diffn nodes are set to Vcc-Vtp and OP′ and ON′ nodes are pulled to Vcc. Transistors MP5, MN6, and MN7, MP8 form two pass gate switches that are turned OFF and break the second stage cross-coupled inverter which disconnects OP & OP′ nodes and ON & ON′ nodes. When the clk and clkb are differentially generated, the clkb is generated by local inversion from clk wherein clk is Vdd at starting of burst (like in DDR/Die-2-Die connections where strobe appears just before the data burst) to disconnect the second stage supply to ground connection through MN6 and MN7 devices in reset phase. So, in reset phase OP and ON nodes are at Vss and OP′ and ON′ nodes are at Vscc as complimentary output phases for tapping.

In evaluation mode, when clkb is equal to Vss and clk is equal to Vcc, transistors MN13 and MN14 are turned OFF. Transistors MP5, MN6 and MN7, MP8 form pass gate switches that are turned ON to complete the second stage cross-coupled inverter by shorting the OP node with the OP′ node, and by shorting the ON node with the ON′ node. These four nets drift towards equilibrium point at mid-rail and ready to resolve once one of the OP or ON nodes reaches below to Vcc-Vtn. As such, SAL 500 improves its T_{CO} compared to other traditional SALs. The nodes diffp and diffn are separated once the differential voltage buildup triggers the second stage outputs to Vcc and Vss.

Once the voltages on the ON and OP nodes are defined by transistors MP3 and MP4, devices will shut off the current from the first stage. As such, power is saved by SAL 500 compared to double tail SALs. The second stage cross-coupled inverter provides faster regeneration of voltages on nodes OP and ON as well as nodes OP′ and ON′, thereby overcoming the impact of series resistance offered by pass gate switches. These devices MP11 and MP12 also enable self-resetting of OP′ and ON′ nodes to supply during reset with slight direct loading from MP11 and MP12 on OP and ON nodes.

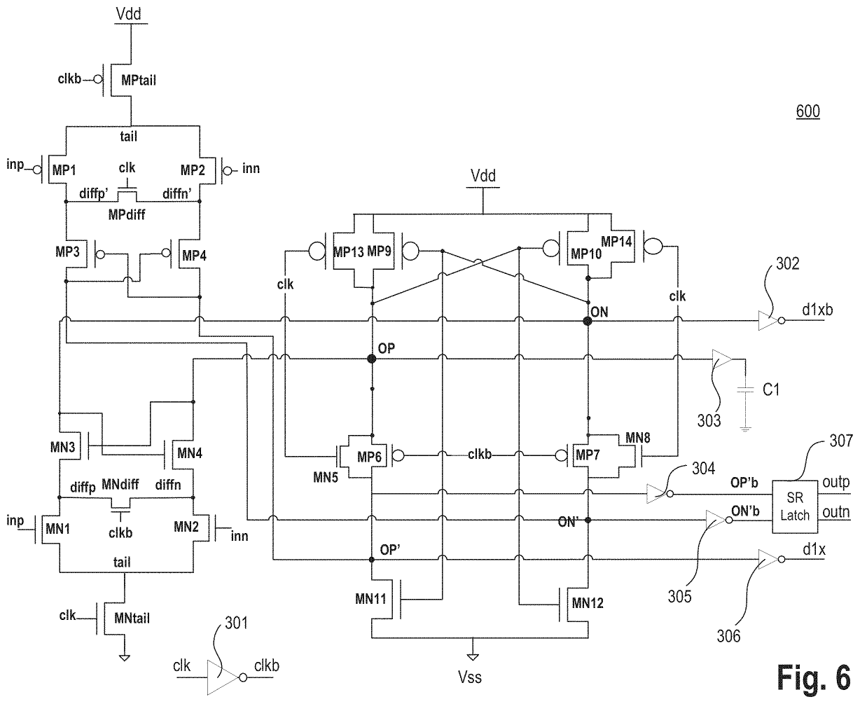

FIG. 6 illustrates SAL 600 with rail-to-rail common voltage, in accordance with some embodiments. The design of SAL 300 can be extrapolated to p-type input pair by keeping the same cross-coupled inverter of the second stage by connecting drains of the p-type input pair to OP′ & ON′ to achieve rail-to-rail common mode voltage. SAL 600 is similar to SAL 300 but for an additional first stage folded to the second stage. This additional first stage comprises clock (clkb) enabled current source MPtail coupled to node tail and supply Vdd, p-type input devices MP1 and MP2 that receive inputs inp and inn, respectively, p-type differential equalizing transistor MPdiff controllable by clk (inverse of clkb) and coupled to nodes diffp′ and diffn′, and cross-coupled p-type transistors MP3 and MP4 which are folded on to the second stage as shown. With the input rail-to-rail common mode support, the architecture of FIG. 3 is extended by having n-type differential pair for victim reaching the SAL through CTLE 101 and DFE, gain stages, while having the p-type differential pair for aggressor crosstalk thereby enabling direct mixing into the cross-coupling inverter stage at the output of SAL.

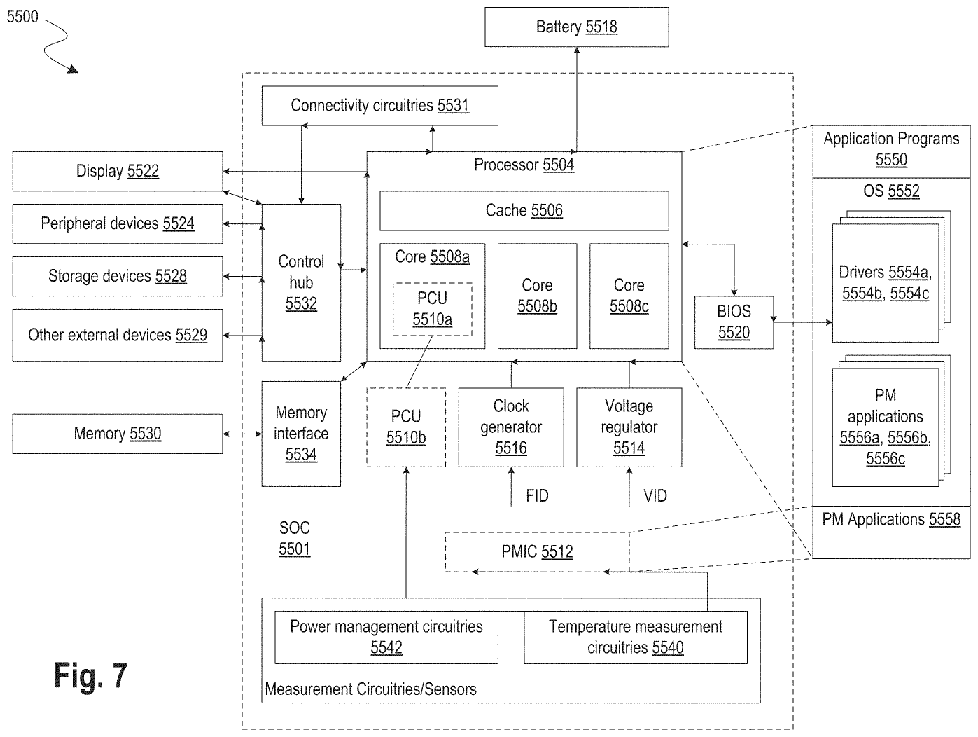

FIG. 7 illustrates a smart device or a computer system or a SoC (System-on-Chip) with SAL, in accordance with some embodiments. It is pointed out that those elements of FIG. 7 having the same reference numbers (or names) as the elements of any other figure may operate or function in any manner similar to that described, but are not limited to such. Any block in this smart device can have the SAL of various embodiments.

In some embodiments, device 5500 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 5500.

In an example, the device 5500 comprises an SoC (System-on-Chip) 5501. An example boundary of the SoC 5501 is illustrated using dotted lines in FIG. 7, with some example components being illustrated to be included within SoC 5501— however, SoC 5501 may include any appropriate components of device 5500.

In some embodiments, device 5500 includes processor 5504. Processor 5504 can include one or more physical devices, such as microprocessors, application processors, microcontrollers, programmable logic devices, processing cores, or other processing implementations such as disaggregated combinations of multiple compute, graphics, accelerator, I/O and/or other processing chips. The processing operations performed by processor 5504 include the execution of an operating platform or operating system on which applications and/or device functions are executed. The processing operations include operations related to I/O (input/output) with a human user or with other devices, operations related to power management, operations related to connecting computing device 5500 to another device, and/or the like. The processing operations may also include operations related to audio I/O and/or display I/O.

In some embodiments, processor 5504 includes multiple processing cores (also referred to as cores) 5508a, 5508b, 5508c. Although merely three cores 5508a, 5508b, 5508c are illustrated in FIG. 7, processor 5504 may include any other appropriate number of processing cores, e.g., tens, or even hundreds of processing cores. Processor cores 5508a, 5508b, 5508c may be implemented on a single integrated circuit (IC) chip. Moreover, the chip may include one or more shared and/or private caches, buses or interconnections, graphics and/or memory controllers, or other components.

In some embodiments, processor 5504 includes cache 5506. In an example, sections of cache 5506 may be dedicated to individual cores 5508 (e.g., a first section of cache 5506 dedicated to core 5508a, a second section of cache 5506 dedicated to core 5508b, and so on). In an example, one or more sections of cache 5506 may be shared among two or more of cores 5508. Cache 5506 may be split in different levels, e.g., level 1 (L1) cache, level 2 (L2) cache, level 3 (L3) cache, etc.

In some embodiments, processor core 5504 may include a fetch unit to fetch instructions (including instructions with conditional branches) for execution by the core 5504. The instructions may be fetched from any storage devices such as the memory 5530. Processor core 5504 may also include a decode unit to decode the fetched instruction. For example, the decode unit may decode the fetched instruction into a plurality of micro-operations. Processor core 5504 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 5504 may be an out-of-order processor core in one embodiment. Processor core 5504 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 5504 may also include a bus unit to enable communication between components of processor core 5504 and other components via one or more buses. Processor core 5504 may also include one or more registers to store data accessed by various components of the core 5504 (such as values related to assigned app priorities and/or sub-system states (modes) association.

In some embodiments, device 5500 comprises connectivity circuitries 5531. For example, connectivity circuitries 5531 includes hardware devices (e.g., wireless and/or wired connectors and communication hardware including an antenna) and/or software components (e.g., drivers, protocol stacks), e.g., to enable device 5500 to communicate with external devices. Device 5500 may be separate from the external devices, such as other computing devices, wireless access points or base stations, etc.

In an example, connectivity circuitries 5531 may include multiple different types of connectivity. To generalize, the connectivity circuitries 5531 may include cellular connectivity circuitries, wireless connectivity circuitries, etc. Cellular connectivity circuitries of connectivity circuitries 5531 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 5531 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 5531 may include a network interface, such as a wired or wireless interface, e.g., so that a system embodiment may be incorporated into a wireless device, for example, a cell phone or personal digital assistant.

In some embodiments, device 5500 comprises control hub 5532, which represents hardware devices and/or software components related to interaction with one or more I/O devices. For example, processor 5504 may communicate with one or more of display 5522, one or more peripheral devices 5524, storage devices 5528, one or more other external devices 5529, etc., via control hub 5532. Control hub 5532 may be a chipset, a Platform Control Hub (PCH), and/or the like.

For example, control hub 5532 illustrates one or more connection points for additional devices that connect to device 5500, e.g., through which a user might interact with the system. For example, devices (e.g., devices 5529) that can be attached to device 5500 include microphone devices, speaker or stereo systems, audio devices, video systems or other display devices, keyboard or keypad devices, or other I/O devices for use with specific applications such as card readers or other devices.

As mentioned above, control hub 5532 can interact with audio devices, display 5522, etc. For example, input through a microphone or other audio device can provide input or commands for one or more applications or functions of device 5500. Additionally, audio output can be provided instead of, or in addition to display output. In another example, if display 5522 includes a touch screen, display 5522 also acts as an input device, which can be at least partially managed by control hub 5532. There can also be additional buttons or switches on computing device 5500 to provide I/O functions managed by control hub 5532. In one embodiment, control hub 5532 manages devices such as accelerometers, cameras, light sensors or other environmental sensors, or other hardware that can be included in device 5500. The input can be part of direct user interaction, as well as providing environmental input to the system to influence its operations (such as filtering for noise, adjusting displays for brightness detection, applying a flash for a camera, or other features).

In some embodiments, control hub 5532 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 5522 represents hardware (e.g., display devices) and software (e.g., drivers) components that provide a visual and/or tactile display for a user to interact with device 5500. Display 5522 may include a display interface, a display screen, and/or hardware device used to provide a display to a user. In some embodiments, display 5522 includes a touch screen (or touch pad) device that provides both output and input to a user. In an example, display 5522 may communicate directly with the processor 5504. Display 5522 can be one or more of an internal display device, as in a mobile electronic device or a laptop device or an external display device attached via a display interface (e.g., DisplayPort, etc.). In one embodiment display 5522 can be a head mounted display (HMD) such as a stereoscopic display device for use in virtual reality (VR) applications or augmented reality (AR) applications.

In some embodiments, and although not illustrated in the figure, in addition to (or instead of) processor 5504, device 5500 may include Graphics Processing Unit (GPU) comprising one or more graphics processing cores, which may control one or more aspects of displaying contents on display 5522.

Control hub 5532 (or platform controller hub) may include hardware interfaces and connectors, as well as software components (e.g., drivers, protocol stacks) to make peripheral connections, e.g., to peripheral devices 5524.

It will be understood that device 5500 could both be a peripheral device to other computing devices, as well as have peripheral devices connected to it. Device 5500 may have a “docking” connector to connect to other computing devices for purposes such as managing (e.g., downloading and/or uploading, changing, synchronizing) content on device 5500. Additionally, a docking connector can allow device 5500 to connect to certain peripherals that allow computing device 5500 to control content output, for example, to audiovisual or other systems.

In addition to a proprietary docking connector or other proprietary connection hardware, device 5500 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 5531 may be coupled to control hub 5532, e.g., in addition to, or instead of, being coupled directly to the processor 5504. In some embodiments, display 5522 may be coupled to control hub 5532, e.g., in addition to, or instead of, being coupled directly to processor 5504.

In some embodiments, device 5500 comprises memory 5530 coupled to processor 5504 via memory interface 5534. Memory 5530 includes memory devices for storing information in device 5500.

In some embodiments, memory 5530 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 5530 can be a dynamic random-access memory (DRAM) device, a static random-access memory (SRAM) device, flash memory device, phase-change memory device, or some other memory device having suitable performance to serve as process memory. In one embodiment, memory 5530 can operate as system memory for device 5500, to store data and instructions for use when the one or more processors 5504 executes an application or process. Memory 5530 can store application data, user data, music, photos, documents, or other data, as well as system data (whether long-term or temporary) related to the execution of the applications and functions of device 5500.

Elements of various embodiments and examples are also provided as a machine-readable medium (e.g., memory 5530) for storing the computer-executable instructions (e.g., instructions to implement any other processes discussed herein). The machine-readable medium (e.g., memory 5530) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 5500 comprises temperature measurement circuitries 5540, e.g., for measuring temperature of various components of device 5500. In an example, temperature measurement circuitries 5540 may be embedded, or coupled or attached to various components, whose temperature are to be measured and monitored. For example, temperature measurement circuitries 5540 may measure temperature of (or within) one or more of cores 5508a, 5508b, 5508c, voltage regulator 5514, memory 5530, a mother-board of SoC 5501, and/or any appropriate component of device 5500. In some embodiments, temperature measurement circuitries 5540 include a low power hybrid reverse (LPHR) bandgap reference (BGR) and digital temperature sensor (DTS), which utilizes subthreshold metal oxide semiconductor (MOS) transistor and the PNP parasitic Bi-polar Junction Transistor (BJT) device to form a reverse BGR that serves as the base for configurable BGR or DTS operating modes. The LPHR architecture uses low-cost MOS transistors and the standard parasitic PNP device. Based on a reverse bandgap voltage, the LPHR can work as a configurable BGR. By comparing the configurable BGR with the scaled base-emitter voltage, the circuit can also perform as a DTS with a linear transfer function with single-temperature trim for high accuracy.

In some embodiments, device 5500 comprises power measurement circuitries 5542, e.g., for measuring power consumed by one or more components of the device 5500. In an example, in addition to, or instead of, measuring power, the power measurement circuitries 5542 may measure voltage and/or current. In an example, the power measurement circuitries 5542 may be embedded, or coupled or attached to various components, whose power, voltage, and/or current consumption are to be measured and monitored. For example, power measurement circuitries 5542 may measure power, current and/or voltage supplied by one or more voltage regulators 5514, power supplied to SoC 5501, power supplied to device 5500, power consumed by processor 5504 (or any other component) of device 5500, etc.

In some embodiments, device 5500 comprises one or more voltage regulator circuitries, generally referred to as voltage regulator (VR) 5514. VR 5514 generates signals at appropriate voltage levels, which may be supplied to operate any appropriate components of the device 5500. Merely as an example, VR 5514 is illustrated to be supplying signals to processor 5504 of device 5500. In some embodiments, VR 5514 receives one or more Voltage Identification (VID) signals, and generates the voltage signal at an appropriate level, based on the VID signals. Various type of VRs may be utilized for the VR 5514. For example, VR 5514 may include a “buck” VR, “boost” VR, a combination of buck and boost VRs, low dropout (LDO) regulators, switching DC-DC regulators, constant-on-time controller-based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 5510a/b and/or PMIC 5512. In some embodiments, each core has a network of distributed LDOs to provide efficient control for power management. The LDOs can be digital, analog, or a combination of digital or analog LDOs. In some embodiments, VR 5514 includes current tracking apparatus to measure current through power supply rail(s).

In some embodiments, VR 5514 includes a digital control scheme to manage states of a proportional-integral-derivative (PID) filter (also known as a digital Type-III compensator). The digital control scheme controls the integrator of the PID filter to implement non-linear control of saturating the duty cycle during which the proportional and derivative terms of the PID are set to 0 while the integrator and its internal states (previous values or memory) is set to a duty cycle that is the sum of the current nominal duty cycle plus a deltaD. The deltaD is the maximum duty cycle increment that is used to regulate a voltage regulator from ICCmin to ICCmax and is a configuration register that can be set post silicon. A state machine moves from a non-linear all ON state (which brings the output voltage Vout back to a regulation window) to an open loop duty cycle which maintains the output voltage slightly higher than the required reference voltage Vref. After a certain period in this state of open loop at the commanded duty cycle, the state machine then ramps down the open loop duty cycle value until the output voltage is close to the Vref commanded. As such, output chatter on the output supply from VR 5514 is completely eliminated (or substantially eliminated) and there is merely a single undershoot transition which could lead to a guaranteed Vmin based on a comparator delay and the di/dt of the load with the available output decoupling capacitance.

In some embodiments, VR 5514 includes a separate self-start controller, which is functional without fuse and/or trim information. The self-start controller protects VR 5514 against large inrush currents and voltage overshoots, while being capable of following a variable VID (voltage identification) reference ramp imposed by the system. In some embodiments, the self-start controller uses a relaxation oscillator built into the controller to set the switching frequency of the buck converter. The oscillator can be initialized using either a clock or current reference to be close to a desired operating frequency. The output of VR 5514 is coupled weakly to the oscillator to set the duty cycle for closed loop operation. The controller is naturally biased such that the output voltage is always slightly higher than the set point, eliminating the need for any process, voltage, and/or temperature (PVT) imposed trims.

In some embodiments, device 5500 comprises one or more clock generator circuitries, generally referred to as clock generator 5516. Clock generator 5516 generates clock signals at appropriate frequency levels, which may be supplied to any appropriate components of device 5500. Merely as an example, clock generator 5516 is illustrated to be supplying clock signals to processor 5504 of device 5500. In some embodiments, clock generator 5516 receives one or more Frequency Identification (FID) signals, and generates the clock signals at an appropriate frequency, based on the FID signals.

In some embodiments, device 5500 comprises battery 5518 supplying power to various components of device 5500. Merely as an example, battery 5518 is illustrated to be supplying power to processor 5504. Although not illustrated in the figures, device 5500 may comprise a charging circuitry, e.g., to recharge the battery, based on Alternating Current (AC) power supply received from an AC adapter.

In some embodiments, battery 5518 periodically checks an actual battery capacity or energy with charge to a preset voltage (e.g., 4.1 V). The battery then decides of the battery capacity or energy. If the capacity or energy is insufficient, then an apparatus in or associated with the battery slightly increases charging voltage to a point where the capacity is sufficient (e.g. from 4.1 V to 4.11 V). The process of periodically checking and slightly increase charging voltage is performed until charging voltage reaches specification limit (e.g., 4.2 V). The scheme described herein has benefits such as battery longevity can be extended, risk of insufficient energy reserve can be reduced, burst power can be used as long as possible, and/or even higher burst power can be used.

In some embodiments, battery 5518 is a multi-battery system with workload dependent load-sharing mechanism. The mechanism is an energy management system that operates in three modes—energy saving mode, balancer mode, and turbo mode. The energy saving mode is a normal mode where the multiple batteries (collectively shown as battery 5518) provide power to their own set of loads with least resistive dissipation. In balancing mode, the batteries are connected through switches operating in active mode so that the current shared is inversely proportion to the corresponding battery state-of-charge. In turbo mode, both batteries are connected in parallel through switches (e.g., on-switches) to provide maximum power to a processor or load. In some embodiments, battery 5518 is a hybrid battery which comprising a fast charging battery and a high energy density battery. Fast charging battery (FC) means a battery capable of faster charging than high energy density battery (HE). FC may be today's Li-ion battery as it is capable of faster charging than HE. In some embodiments, a controller (part of battery 5518) optimizes the sequence and charging rate for the hybrid battery to maximize both the charging current and charging speed of the battery, while enabling longer battery life.

In some embodiments, the charging circuitry (e.g., 5518) comprises a buck-boost converter. This buck-boost converter comprises DrMOS or DrGaN devices used in place of half-bridges for traditional buck-boost converters. Various embodiments here are described with reference to DrMOS. However, the embodiments are applicable to DrGaN. The DrMOS devices allow for better efficiency in power conversion due to reduced parasitic and optimized MOSFET packaging. Since the dead-time management is internal to the DrMOS, the dead-time management is more accurate than for traditional buck-boost converters leading to higher efficiency in conversion. Higher frequency of operation allows for smaller inductor size, which in turn reduces the z-height of the charger comprising the DrMOS based buck-boost converter. The buck-boost converter of various embodiments comprises dual-folded bootstrap for DrMOS devices. In some embodiments, in addition to the traditional bootstrap capacitors, folded bootstrap capacitors are added that cross-couple inductor nodes to the two sets of DrMOS switches.

In some embodiments, device 5500 comprises Power Control Unit (PCU) 5510 (also referred to as Power Management Unit (PMU), Power Management Controller (PMC), Power Unit (p-unit), etc.). In an example, some sections of PCU 5510 may be implemented by one or more processing cores 5508, and these sections of PCU 5510 are symbolically illustrated using a dotted box and labelled PCU 5510a. In an example, some other sections of PCU 5510 may be implemented outside the processing cores 5508, and these sections of PCU 5510 are symbolically illustrated using a dotted box and labelled as PCU 5510b. PCU 5510 may implement various power management operations for device 5500. PCU 5510 may include hardware interfaces, hardware circuitries, connectors, registers, etc., as well as software components (e.g., drivers, protocol stacks), to implement various power management operations for device 5500.

In various embodiments, PCU or PMU 5510 is organized in a hierarchical manner forming a hierarchical power management (HPM). HPM of various embodiments builds a capability and infrastructure that allows for package level management for the platform, while still catering to islands of autonomy that might exist across the constituent die in the package. HPM does not assume a pre-determined mapping of physical partitions to domains. An HPM domain can be aligned with a function integrated inside a dielet, to a dielet boundary, to one or more dielets, to a companion die, or even a discrete CXL device. HPM addresses integration of multiple instances of the same die, mixed with proprietary functions or 3rd party functions integrated on the same die or separate die, and even accelerators connected via CXL (e.g., Flexbus) that may be inside the package, or in a discrete form factor.

HPM enables designers to meet the goals of scalability, modularity, and late binding. HPM also allows PMU functions that may already exist on other dice to be leveraged, instead of being disabled in the flat scheme. HPM enables management of any arbitrary collection of functions independent of their level of integration. HPM of various embodiments is scalable, modular, works with symmetric multi-chip processors (MCPs), and works with asymmetric MCPs. For example, HPM does not need a signal PM controller and package infrastructure to grow beyond reasonable scaling limits. HPM enables late addition of a die in a package without the need for change in the base die infrastructure. HPM addresses the need of disaggregated solutions having dies of different process technology nodes coupled in a single package. HPM also addresses the needs of companion die integration solutions—on and off package.

In various embodiments, each die (or dielet) includes a power management unit (PMU) or p-unit. For example, processor dies can have a supervisor p-unit, supervisee p-unit, or a dual role supervisor/supervisee p-unit. In some embodiments, an I/O die has its own dual role p-unit such as supervisor and/or supervisee p-unit. The p-units in each die can be instances of a generic p-unit. In one such example, all p-units have the same capability and circuits, but are configured (dynamically or statically) to take a role of a supervisor, supervisee, and/or both. In some embodiments, the p-units for compute dies are instances of a compute p-unit while p-units for IO dies are instances of an IO p-unit different from the compute p-unit. Depending on the role, p-unit acquires specific responsibilities to manage power of the multichip module and/or computing platform. While various p-units are described for dies in a multichip module or system-on-chip, a p-unit can also be part of an external device such as I/O device.

Here, the various p-units do not have to be the same. The HPM architecture can operate very different types of p-units. One common feature for the p-units is that they are expected to receive HPM messages and are expected to be able to comprehend them. In some embodiments, the p-unit of IO dies may be different than the p-unit of the compute dies. For example, the number of register instances of each class of register in the IO p-unit is different than those in the p-units of the compute dies. An IO die has the capability of being an HPM supervisor for CXL connected devices, but compute die may not need to have that capability. The IO and computes dice also have different firmware flows and possibly different firmware images. These are choices that an implementation can make. An HPM architecture can choose to have one superset firmware image and selectively execute flows that are relevant to the die type the firmware is associated with. Alternatively, there can be a customer firmware for each p-unit type; it can allow for more streamlined sizing of the firmware storage requirements for each p-unit type.

The p-unit in each die can be configured as a supervisor p-unit, supervisee p-unit or with a dual role of supervisor/supervisee. As such, p-units can perform roles of supervisor or supervisee for various domains. In various embodiments, each instance of p-unit is capable of autonomously managing local dedicated resources and contains structures to aggregate data and communicate between instances to enable shared resource management by the instance configured as the shared resource supervisor. A message and wire-based infrastructure is provided that can be duplicated and configured to facilitate management and flows between multiple p-units.

In some embodiments, power and thermal thresholds are communicated by a supervisor p-unit to supervisee p-units. For example, a supervisor p-unit learns of the workload (present and future) of each die, power measurements of each die, and other parameters (e.g., platform level power boundaries) and determines new power limits for each die. These power limits are then communicated by supervisor p-units to the supervisee p-units via one or more interconnects and fabrics. In some embodiments, a fabric indicates a group of fabrics and interconnect including a first fabric, a second fabric, and a fast response interconnect. In some embodiments, the first fabric is used for common communication between a supervisor p-unit and a supervisee p-unit. These common communications include change in voltage, frequency, and/or power state of a die which is planned based on a number of factors (e.g., future workload, user behavior, etc.). In some embodiments, the second fabric is used for higher priority communication between supervisor p-unit and supervisee p-unit. Example of higher priority communication include a message to throttle because of a possible thermal runaway condition, reliability issue, etc. In some embodiments, a fast response interconnect is used for communicating fast or hard throttle of all dies. In this case, a supervisor p-unit may send a fast throttle message to all other p-units, for example. In some embodiments, a fast response interconnect is a legacy interconnect whose function can be performed by the second fabric.

The HPM architecture of various embodiments enables scalability, modularity, and late binding of symmetric and/or asymmetric dies. Here, symmetric dies are dies of same size, type, and/or function, while asymmetric dies are dies of different size, type, and/or function. Hierarchical approach also allows PMU functions that may already exist on other dice to be leveraged, instead of being disabled in the traditional flat power management scheme. HPM does not assume a pre-determined mapping of physical partitions to domains. An HPM domain can be aligned with a function integrated inside a dielet, to a dielet boundary, to one or more dielets, to a companion die, or even a discrete CXL device. HPM enables management of any arbitrary collection of functions independent of their level of integration. In some embodiments, a p-unit is declared a supervisor p-unit based on one or more factors. These factors include memory size, physical constraints (e.g., number of pin-outs), and locations of sensors (e.g., temperature, power consumption, etc.) to determine physical limits of the processor.

The HPM architecture of various embodiments, provides a means to scale power management so that a single p-unit instance does not need to be aware of the entire processor. This enables power management at a smaller granularity and improves response times and effectiveness. Hierarchical structure maintains a monolithic view to the user. For example, at an operating system (OS) level, HPM architecture gives the OS a single PMU view even though the PMU is physically distributed in one or more supervisor-supervisee configurations.

In some embodiments, the HPM architecture is centralized where one supervisor controls all supervisees. In some embodiments, the HPM architecture is decentralized, wherein various p-units in various dies control overall power management by peer-to-peer communication. In some embodiments, the HPM architecture is distributed where there are different supervisors for different domains. One example of a distributed architecture is a tree-like architecture.

In some embodiments, device 5500 comprises Power Management Integrated Circuit (PMIC) 5512, e.g., to implement various power management operations for device 5500. In some embodiments, PMIC 5512 is a Reconfigurable Power Management ICs (RPMICs) and/or an IMVP (Intel® Mobile Voltage Positioning). In an example, the PMIC is within an IC die separate from processor 5504. The may implement various power management operations for device 5500. PMIC 5512 may include hardware interfaces, hardware circuitries, connectors, registers, etc., as well as software components (e.g., drivers, protocol stacks), to implement various power management operations for device 5500.

In an example, device 5500 comprises one or both PCU 5510 or PMIC 5512. In an example, any one of PCU 5510 or PMIC 5512 may be absent in device 5500, and hence, these components are illustrated using dotted lines.

Various power management operations of device 5500 may be performed by PCU 5510, by PMIC 5512, or by a combination of PCU 5510 and PMIC 5512. For example, PCU 5510 and/or PMIC 5512 may select a power state (e.g., P-state) for various components of device 5500. For example, PCU 5510 and/or PMIC 5512 may select a power state (e.g., in accordance with the ACPI (Advanced Configuration and Power Interface) specification) for various components of device 5500. Merely as an example, PCU 5510 and/or PMIC 5512 may cause various components of the device 5500 to transition to a sleep state, to an active state, to an appropriate C state (e.g., C0 state, or another appropriate C state, in accordance with the ACPI specification), etc. In an example, PCU 5510 and/or PMIC 5512 may control a voltage output by VR 5514 and/or a frequency of a clock signal output by the clock generator, e.g., by outputting the VID signal and/or the FID signal, respectively. In an example, PCU 5510 and/or PMIC 5512 may control battery power usage, charging of battery 5518, and features related to power saving operation.

The clock generator 5516 can comprise a phase locked loop (PLL), frequency locked loop (FLL), or any suitable clock source. In some embodiments, each core of processor 5504 has its own clock source. As such, each core can operate at a frequency independent of the frequency of operation of the other core. In some embodiments, PCU 5510 and/or PMIC 5512 performs adaptive or dynamic frequency scaling or adjustment. For example, clock frequency of a processor core can be increased if the core is not operating at its maximum power consumption threshold or limit. In some embodiments, PCU 5510 and/or PMIC 5512 determines the operating condition of each core of a processor, and opportunistically adjusts frequency and/or power supply voltage of that core without the core clocking source (e.g., PLL of that core) losing lock when the PCU 5510 and/or PMIC 5512 determines that the core is operating below a target performance level. For example, if a core is drawing current from a power supply rail less than a total current allocated for that core or processor 5504, then PCU 5510 and/or PMIC 5512 can temporality increase the power draw for that core or processor 5504 (e.g., by increasing clock frequency and/or power supply voltage level) so that the core or processor 5504 can perform at higher performance level. As such, voltage and/or frequency can be increased temporality for processor 5504 without violating product reliability.

In an example, PCU 5510 and/or PMIC 5512 may perform power management operations, e.g., based at least in part on receiving measurements from power measurement circuitries 5542, temperature measurement circuitries 5540, charge level of battery 5518, and/or any other appropriate information that may be used for power management. To that end, PMIC 5512 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 5510 and/or PMIC 5512 in at least one embodiment to allow PCU 5510 and/or PMIC 5512 to manage processor core energy at least in part based on value(s) detected by one or more of the sensors.

Also illustrated is an example software stack of device 5500 (although not all elements of the software stack are illustrated). Merely as an example, processors 5504 may execute application programs 5550, Operating System 5552, one or more Power Management (PM) specific application programs (e.g., generically referred to as PM applications 5558), and/or the like. PM applications 5558 may also be executed by the PCU 5510 and/or PMIC 5512. OS 5552 may also include one or more PM applications 5556a, 5556b, 5556c. The OS 5552 may also include various drivers 5554a, 5554b, 5554c, etc., some of which may be specific for power management purposes. In some embodiments, device 5500 may further comprise a Basic Input/output System (BIOS) 5520. BIOS 5520 may communicate with OS 5552 (e.g., via one or more drivers 5554), communicate with processors 5504, etc.

For example, one or more of PM applications 5558, 5556, drivers 5554, BIOS 5520, etc. may be used to implement power management specific tasks, e.g., to control voltage and/or frequency of various components of device 5500, to control wake-up state, sleep state, and/or any other appropriate power state of various components of device 5500, control battery power usage, charging of the battery 5518, features related to power saving operation, etc.

In some embodiments, battery 5518 is a Li-metal battery with a pressure chamber to allow uniform pressure on a battery. The pressure chamber is supported by metal plates (such as pressure equalization plate) used to give uniform pressure to the battery. The pressure chamber may include pressured gas, elastic material, spring plate, etc. The outer skin of the pressure chamber is free to bow, restrained at its edges by (metal) skin, but still exerts a uniform pressure on the plate that is compressing the battery cell. The pressure chamber gives uniform pressure to battery, which is used to enable high-energy density battery with, for example, 20% more battery life.

In some embodiments, battery 5518 includes hybrid technologies. For example, a mix of high energy density charge (e.g., Li-Ion batteries) carrying device(s) and low energy density charge carrying devices (e.g., supercapacitor) are used as batteries or storage devices. In some embodiments, a controller (e.g., hardware, software, or a combination of them) is used analyze peak power patterns and minimizes the impact to overall lifespan of high energy density charge carrying device-based battery cells while maximizing service time for peak power shaving feature. The controller may be part of battery 5518 or part of p-unit 5510b.

In some embodiments, pCode executing on PCU 5510a/b has a capability to enable extra compute and telemetries resources for the runtime support of the pCode. Here pCode refers to a firmware executed by PCU 5510a/b to manage performance of the SoC 5501. For example, pCode may set frequencies and appropriate voltages for the processor. Part of the pCode are accessible via OS 5552. In various embodiments, mechanisms and methods are provided that dynamically change an Energy Performance Preference (EPP) value based on workloads, user behavior, and/or system conditions. There may be a well-defined interface between OS 5552 and the pCode. The interface may allow or facilitate the software configuration of several parameters and/or may provide hints to the pCode. As an example, an EPP parameter may inform a pCode algorithm as to whether performance or battery life is more important.

This support may be done as well by the OS 5552 by including machine-learning support as part of OS 5552 and either tuning the EPP value that the OS hints to the hardware (e.g., various components of SoC 5501) by machine-learning prediction, or by delivering the machine-learning prediction to the pCode in a manner similar to that done by a Dynamic Tuning Technology (DTT) driver. In this model, OS 5552 may have visibility to the same set of telemetries as are available to a DTT. As a result of a DTT machine-learning hint setting, pCode may tune its internal algorithms to achieve optimal power and performance results following the machine-learning prediction of activation type. The pCode as example may increase the responsibility for the processor utilization change to enable fast response for user activity, or may increase the bias for energy saving either by reducing the responsibility for the processor utilization or by saving more power and increasing the performance lost by tuning the energy saving optimization. This approach may facilitate saving more battery life in case the types of activities enabled lose some performance level over what the system can enable. The pCode may include an algorithm for dynamic EPP that may take the two inputs, one from OS 5552 and the other from software such as DTT, and may selectively choose to provide higher performance and/or responsiveness. As part of this method, the pCode may enable in the DTT an option to tune its reaction for the DTT for different types of activity.

In some embodiments, pCode improves the performance of the SoC in battery mode. In some embodiments, pCode allows drastically higher SoC peak power limit levels (and thus higher Turbo performance) in battery mode. In some embodiments, pCode implements power throttling and is part of Intel's Dynamic Tuning Technology (DTT). In various embodiments, the peak power limit is referred to PL4. However, the embodiments are applicable to other peak power limits. In some embodiments, pCode sets the Vth threshold voltage (the voltage level at which the platform will throttle the SoC) in such a way as to prevent the system from unexpected shutdown (or black screening). In some embodiments, pCode calculates the Psoc,pk SoC Peak Power Limit (e.g., PL4), according to the threshold voltage (Vth). These are two dependent parameters, if one is set, the other can be calculated. pCode is used to optimally set one parameter (Vth) based on the system parameters, and the history of the operation. In some embodiments, pCode provides a scheme to dynamically calculate the throttling level (Psoc,th) based on the available battery power (which changes slowly) and set the SoC throttling peak power (Psoc,th). In some embodiments, pCode decides the frequencies and voltages based on Psoc,th. In this case, throttling events have less negative effect on the SoC performance Various embodiments provide a scheme which allows maximum performance (Pmax) framework to operate.

In some embodiments, VR 5514 includes a current sensor to sense and/or measure current through a high-side switch of VR 5514. In some embodiments the current sensor uses an amplifier with capacitively coupled inputs in feedback to sense the input offset of the amplifier, which can be compensated for during measurement. In some embodiments, the amplifier with capacitively coupled inputs in feedback is used to operate the amplifier in a region where the input common-mode specifications are relaxed, so that the feedback loop gain and/or bandwidth is higher. In some embodiments, the amplifier with capacitively coupled inputs in feedback is used to operate the sensor from the converter input voltage by employing high-PSRR (power supply rejection ratio) regulators to create a local, clean supply voltage, causing less disruption to the power grid in the switch area. In some embodiments, a variant of the design can be used to sample the difference between the input voltage and the controller supply, and recreate that between the drain voltages of the power and replica switches. This allows the sensor to not be exposed to the power supply voltage. In some embodiments, the amplifier with capacitively coupled inputs in feedback is used to compensate for power delivery network related (PDN-related) changes in the input voltage during current sensing.

Some embodiments use three components to adjust the peak power of SoC 5501 based on the states of a USB TYPE-C device 5529. These components include OS Peak Power Manager (part of OS 5552), USB TYPE-C Connector Manager (part of OS 5552), and USB TYPE-C Protocol Device Driver (e.g., one of drivers 5554a, 5554b, 5554c). In some embodiments, the USB TYPE-C Connector Manager sends a synchronous request to the OS Peak Power Manager when a USB TYPE-C power sink device is attached or detached from SoC 5501, and the USB TYPE-C Protocol Device Driver sends a synchronous request to the Peak Power Manager when the power sink transitions device state. In some embodiments, the Peak Power Manager takes power budget from the CPU when the USB TYPE-C connector is attached to a power sink and is active (e.g., high power device state).

In some embodiments, the Peak Power Manager gives back the power budget to the CPU for performance when the USB TYPE-C connector is either detached or the attached and power sink device is idle (lowest device state).

In some embodiments, logic is provided to dynamically pick the best operating processing core for BIOS power-up flows and sleep exit flows (e.g., S3, S4, and/or S5). The selection of the bootstrap processor (BSP) is moved to an early power-up time instead of a fixed hardware selection at any time. For maximum boot performance, the logic selects the fastest capable core as the BSP at an early power-up time. In addition, for maximum power saving, the logic selects the most power efficient core as the BSP. Processor or switching for selecting the BSP happens during the boot-up as well as power-up flows (e.g., S3, S4, and/or S5 flows).

In some embodiments, the memories herein are organized in multi-level memory architecture and their performance is governed by a decentralized scheme. The decentralized scheme includes p-unit 5510 and memory controllers. In some embodiments, the scheme dynamically balances a number of parameters such as power, thermals, cost, latency and performance for memory levels that are progressively further away from the processor in platform 5500 based on how applications are using memory levels that are further away from processor cores. In some examples, the decision making for the state of the far memory (FM) is decentralized. For example, a processor power management unit (p-unit), near memory controller (NMC), and/or far memory host controller (FMHC) makes decisions about the power and/or performance state of the FM at their respective levels. These decisions are coordinated to provide the most optimum power and/or performance state of the FM for a given time. The power and/or performance state of the memories adaptively change to changing workloads and other parameters even when the processor(s) is in a particular power state.

In some embodiments, a hardware and software coordinated processor power state policy (e.g., policy for C-state) is implemented that delivers optimal power state selection by taking in to account the performance and/or responsiveness needs of thread expected to be scheduled on the core entering idle, to achieve improved instructions per cycle (IPC) and performance for cores running user critical tasks. The scheme provides the ability to deliver responsiveness gains for important and/or user-critical threads running on a system-on-chip. P-unit 5510 which coupled to the plurality of processing cores, receives a hint from operating system 5552 indicative of a bias towards a power state or performance state for at least one of the processing cores of the plurality of processing cores based on a priority of a thread in context switch.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “adjacent” here generally refers to a position of a thing being next to (e g, immediately next to or close to with one or more things between them) or adjoining another thing (e.g., abutting it).

The term “circuit” or “module” may refer to one or more passive and/or active components that are arranged to cooperate with one another to provide a desired function.

The term “signal” may refer to at least one current signal, voltage signal, magnetic signal, or data/clock signal. The meaning of “a,” “an,” and “the” include plural references. The meaning of “in” includes “in” and “on.”

The term “analog signal” is any continuous signal for which the time varying feature (variable) of the signal is a representation of some other time varying quantity, i.e., analogous to another time varying signal.

The term “digital signal” is a physical signal that is a representation of a sequence of discrete values (a quantified discrete-time signal), for example of an arbitrary bit stream, or of a digitized (sampled and analog-to-digital converted) analog signal.

The term “scaling” generally refers to converting a design (schematic and layout) from one process technology to another process technology and may be subsequently being reduced in layout area. In some cases, scaling also refers to upsizing a design from one process technology to another process technology and may be subsequently increasing layout area. The term “scaling” generally also refers to downsizing or upsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom, “over,” “under,” and the like in the description and in the claims, if any, are used for descriptive purposes and not necessarily for describing permanent relative positions.

It is pointed out that those elements of the figures having the same reference numbers (or names) as the elements of any other figure can operate or function in any manner similar to that described but are not limited to such.

For purposes of the embodiments, the transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TI-BT device, on the other hand, has asymmetric Source and Drain terminals. Those skilled in the art will appreciate that other transistors, for example, Bi-polar junction transistors (BJT PNP/NPN), BiCMOS, CMOS, etc., may be used without departing from the scope of the disclosure.

Here the term “die” generally refers to a single continuous piece of semiconductor material (e.g. silicon) where transistors or other components making up a processor core may reside. Multi-core processors may have two or more processors on a single die, but alternatively, the two or more processors may be provided on two or more respective dies. Each die has a dedicated power controller or power control unit (p-unit) power controller or power control unit (p-unit) which can be dynamically or statically configured as a supervisor or supervisee. In some examples, dies are of the same size and functionality i.e., symmetric cores. However, dies can also be asymmetric. For example, some dies have different size and/or function than other dies. Each processor may also be a dielet or chiplet.

Here the term “dielet” or “chiplet” generally refers to a physically distinct semiconductor die, typically connected to an adjacent die in a way that allows the fabric across a die boundary to function like a single fabric rather than as two distinct fabrics. Thus at least some dies may be dielets. Each dielet may include one or more p-units which can be dynamically or statically configured as a supervisor, supervisee or both.

Here the term “fabric” generally refers to communication mechanism having a known set of sources, destinations, routing rules, topology and other properties. The sources and destinations may be any type of data handling functional unit such as power management units. Fabrics can be two-dimensional spanning along an x-y plane of a die and/or three-dimensional (3D) spanning along an x-y-z plane of a stack of vertical and horizontally positioned dies. A single fabric may span multiple dies. A fabric can take any topology such as mesh topology, star topology, daisy chain topology. A fabric may be part of a network-on-chip (NoC) with multiple agents. These agents can be any functional unit.

Here, the term “processor core” generally refers to an independent execution unit that can run one program thread at a time in parallel with other cores. A processor core may include a dedicated power controller or power control unit (p-unit) which can be dynamically or statically configured as a supervisor or supervisee. This dedicated p-unit is also referred to as an autonomous p-unit, in some examples. In some examples, all processor cores are of the same size and functionality i.e., symmetric cores. However, processor cores can also be asymmetric. For example, some processor cores have different size and/or function than other processor cores. A processor core can be a virtual processor core or a physical processor core.

Here, the term “interconnect” refers to a communication link, or channel, between two or more points or nodes. It may comprise one or more separate conduction paths such as wires, vias, waveguides, passive components, and/or active components. It may also comprise a fabric. In some embodiments, a p-unit is coupled to an OS via an interface.

Here the term “interface” generally refers to software and/or hardware used to communicate with an interconnect. An interface may include logic and I/O driver/receiver to send and receive data over the interconnect or one or more wires.

Here the term “domain” generally refers to a logical or physical perimeter that has similar properties (e.g., supply voltage, operating frequency, type of circuits or logic, and/or workload type) and/or is controlled by a particular agent. For example, a domain may be a group of logic units or function units that are controlled by a particular supervisor. A domain may also be referred to an Autonomous Perimeter (AP). A domain can be an entire system-on-chip (SoC) or part of the SoC, and is governed by a p-unit.

Here the term “supervisor” generally refers to a power controller, or power management, unit (a “p-unit”), which monitors and manages power and performance related parameters for one or more associated power domains, either alone or in cooperation with one or more other p-units. Power/performance related parameters may include but are not limited to domain power, platform power, voltage, voltage domain current, die current, load-line, temperature, device latency, utilization, clock frequency, processing efficiency, current/future workload information, and other parameters. It may determine new power or performance parameters (limits, average operational, etc.) for the one or more domains. These parameters may then be communicated to supervisee p-units, or directly to controlled or monitored entities such as VR or clock throttle control registers, via one or more fabrics and/or interconnects. A supervisor learns of the workload (present and future) of one or more dies, power measurements of the one or more dies, and other parameters (e.g., platform level power boundaries) and determines new power limits for the one or more dies. These power limits are then communicated by supervisor p-units to the supervisee p-units via one or more fabrics and/or interconnect. In examples where a die has one p-unit, a supervisor (Svor) p-unit is also referred to as supervisor die.

Here the term “supervisee” generally refers to a power controller, or power management, unit (a “p-unit”), which monitors and manages power and performance related parameters for one or more associated power domains, either alone or in cooperation with one or more other p-units and receives instructions from a supervisor to set power and/or performance parameters (e.g., supply voltage, operating frequency, maximum current, throttling threshold, etc.) for its associated power domain. In examples where a die has one p-unit, a supervisee (Svee) p-unit may also be referred to as a supervisee die. Note that a p-unit may serve either as a Svor, a Svee, or both a Svor/Svee p-unit

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

Various embodiments are provided as examples. These examples can be combined with any other example to form distinct embodiments. For example, example 4 can be combined with example 7.

Example 1: A sense amplifier latch, comprising: a first stage having a differential input pair and cross-coupled transistors coupled to the differential input pair; and a second stage coupled to the first stage such that the first stage is to fold in to the second stage, wherein the second stage comprises cross-coupled inverters.

Example 2: The sense amplifier latch of example 1, wherein the cross-coupled inverters comprise a first inverter and a second inverter, wherein the sense amplifier latch comprises a first pass gate controllable by a clock, wherein the first pass-gate is to couple or de-couple transistors of the first inverter from a first output of the first inverter, wherein the first output is coupled to an input of the second inverter.

Example 3: The sense amplifier latch of example 2, wherein the sense amplifier latch comprises a second pass gate controllable by the clock, wherein the second pass-gate is to couple or de-couple transistors of the second inverter from a second output of the first inverter, wherein the second output is coupled to an input of the first inverter.

Example 4: The sense amplifier latch of example 1 comprises a first device coupled in parallel to a transistor of the first inverter, and also coupled to a supply rail.

Example 5: The sense amplifier latch of example 4 comprises a second device coupled in parallel to a transistor of the second inverter, and also coupled to the supply rail.

Example 6: The sense amplifier latch of example 5 comprises: a first driver coupled to the transistor of the first inverter; and a second driver coupled to the transistor of the second inverter.

Example 7: The sense amplifier latch of example 1 comprises: a first transistor coupled to the differential input pair and cross-coupled transistors, wherein the first transistor is controllable by a first clock; and a second transistor coupled to the differential input pair and a reference supply, and controllable by a second clock, wherein the second clock is an inverse of the first clock.

Example 8: The sense amplifier latch of example 1 comprises a cross-talk cancellation circuitry coupled to the differential pair.

Example 9: The sense amplifier latch of example 8 comprises a high-pass filter coupled to the cross-talk cancellation circuitry coupled to the differential pair.

Example 10: The sense amplifier latch of example 1 comprises a voltage offset control circuitry coupled to the differential pair.

Example 11: A sense amplifier latch, comprising: a first stage having a differential input pair and cross-coupled transistors coupled to the differential input pair; and a second stage coupled to the first stage, wherein the second stage is to sum currents from the first stage and the second stage.

Example 12: The sense amplifier latch of example 11, wherein the second stage comprises cross-coupled inverters which include a first inverter and a second inverter, wherein the sense amplifier latch comprises a first pass gate controllable by a clock, wherein the first pass-gate is to couple or de-couple transistors of the first inverter from a first output of the first inverter, wherein the first output is coupled to an input of the second inverter.

Example 13: The sense amplifier latch of example 12, wherein the sense amplifier latch comprises a second pass gate controllable by the clock, wherein the second pass-gate is to couple or de-couple transistors of the second inverter from a second output of the first inverter, wherein the second output is coupled to an input of the first inverter.

Example 14: The sense amplifier latch of example 11 comprises a cross-talk cancellation circuitry coupled to the differential pair.

Example 15: The sense amplifier latch of example 14 comprises a high-pass filter coupled to the cross-talk cancellation circuitry coupled to the differential pair.

Example 16: The sense amplifier latch of example 11 comprises a voltage offset control circuitry coupled to the differential pair.

Example 17: A system comprising: a memory; a processor coupled to the memory; an antenna communicatively coupled to the processor, wherein the processor includes a receiver which comprises: an analog front-end; a summing node coupled to an output of the analog front-end; a sampler coupled to the summing node, wherein the sampler includes: a first stage having a differential input pair and cross-coupled transistors coupled to the differential input pair; and a second stage coupled to the first stage such that the first stage is to fold in to the second stage, wherein the second stage comprises cross-coupled inverters.

Example 18: The system of example 17, wherein the cross-coupled inverters comprises a first inverter and a second inverter, wherein the sampler comprises a first pass gate controllable by a clock, wherein the first pass-gate is to couple or de-couple transistors of the first inverter from a first output of the first inverter, wherein the first output is coupled to an input of the second inverter.

Example 19: The system of example 18, wherein the sampler comprises a second pass gate controllable by the clock, wherein the second pass-gate is to couple or de-couple transistors of the second inverter from a second output of the first inverter, wherein the second output is coupled to an input of the first inverter.

Example 20: The system of example 17 comprises a cross-talk cancellation circuitry coupled to the differential pair.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. A sense amplifier latch, comprising:
a first stage having a differential input pair and cross-coupled transistors coupled to the differential input pair; and
a second stage coupled to the first stage such that the first stage is to fold in to the second stage, wherein the second stage comprises cross-coupled inverters.

2. The sense amplifier latch of claim 1, wherein the cross-coupled inverters comprise a first inverter and a second inverter, wherein the sense amplifier latch comprises a first pass gate controllable by a clock, wherein the first pass-gate is to couple or de-couple transistors of the first inverter from a first output of the first inverter, wherein the first output is coupled to an input of the second inverter.

3. The sense amplifier latch of claim 2, wherein the sense amplifier latch comprises a second pass gate controllable by the clock, wherein the second pass-gate is to couple or de-couple transistors of the second inverter from a second output of the first inverter, wherein the second output is coupled to an input of the first inverter.

4. The sense amplifier latch of claim 1 comprises a first device coupled in parallel to a transistor of the first inverter, and also coupled to a supply rail.

5. The sense amplifier latch of claim 4 comprises a second device coupled in parallel to a transistor of the second inverter, and also coupled to the supply rail.

6. The sense amplifier latch of claim 5 comprises:
a first driver coupled to the transistor of the first inverter; and
a second driver coupled to the transistor of the second inverter.

7. The sense amplifier latch of claim 1 comprises:
a first transistor coupled to the differential input pair and cross-coupled transistors, wherein the first transistor is controllable by a first clock; and
a second transistor coupled to the differential input pair and a reference supply, and controllable by a second clock, wherein the second clock is an inverse of the first clock.

8. The sense amplifier latch of claim 1 comprises a cross-talk cancellation circuitry coupled to the differential pair.

9. The sense amplifier latch of claim 8 comprises a high-pass filter coupled to the cross-talk cancellation circuitry coupled to the differential pair.

10. The sense amplifier latch of claim 1 comprises a voltage offset control circuitry coupled to the differential pair.

11. A sense amplifier latch, comprising:
a first stage having a differential input pair and cross-coupled transistors coupled to the differential input pair; and
a second stage coupled to the first stage, wherein the second stage is to sum currents from the first stage and the second stage.

12. The sense amplifier latch of claim 11, wherein the second stage comprises cross-coupled inverters which include a first inverter and a second inverter, wherein the sense amplifier latch comprises a first pass gate controllable by a clock, wherein the first pass-gate is to couple or de-couple transistors of the first inverter from a first output of the first inverter, wherein the first output is coupled to an input of the second inverter.

13. The sense amplifier latch of claim 12, wherein the sense amplifier latch comprises a second pass gate controllable by the clock, wherein the second pass-gate is to couple or de-couple transistors of the second inverter from a second output of the first inverter, wherein the second output is coupled to an input of the first inverter.

14. The sense amplifier latch of claim 11 comprises a cross-talk cancellation circuitry coupled to the differential pair.

15. The sense amplifier latch of claim 14 comprises a high-pass filter coupled to the cross-talk cancellation circuitry coupled to the differential pair.

16. The sense amplifier latch of claim 11 comprises a voltage offset control circuitry coupled to the differential pair.

17. A system comprising:
a memory;
a processor coupled to the memory; and
an antenna communicatively coupled to the processor, wherein the processor includes a receiver which comprises:
an analog front-end;
a summing node coupled to an output of the analog front-end;
a sampler coupled to the summing node, wherein the sampler includes:
a first stage having a differential input pair and cross-coupled transistors coupled to the differential input pair; and
a second stage coupled to the first stage such that the first stage is to fold in to the second stage, wherein the second stage comprises cross-coupled inverters.

18. The system of claim 17, wherein the cross-coupled inverters comprises a first inverter and a second inverter, wherein the sampler comprises a first pass gate controllable by a clock, wherein the first pass-gate is to couple or de-couple transistors of the first inverter from a first output of the first inverter, wherein the first output is coupled to an input of the second inverter.

19. The system of claim 18, wherein the sampler comprises a second pass gate controllable by the clock, wherein the second pass-gate is to couple or de-couple transistors of the second inverter from a second output of the first inverter, wherein the second output is coupled to an input of the first inverter.

20. The system of claim 17 comprises a cross-talk cancellation circuitry coupled to the differential pair.
